(19) United States
(12) Patent Application Publication
(10) Pub. No.: US 2009/0124281 A1
(43) Pub. Date: May 14, 2009

(54) INFORMATION PROCESSING APPARATUS CAPABLE OF OUTGOING AND INCOMING CALLS

(75) Inventors: Akira TAKAMUNE, Tokyo (JP); Youichi Hasebe, Tokyo (JP); Tomohiro Yoshida, Tokyo (JP); Yuri Saitou, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/247,362

(22) Filed: Oct. 8, 2008

(30) Foreign Application Priority Data
Nov. 12, 2007 (JP) P2007-293295

(51) Int. Cl. H04M 1/00

(52) U.S. Cl. 455/550.1

(57) ABSTRACT

In an information processing apparatus according to an embodiment of the present invention, a Bluetooth module establishes a communication with an external device via the short distance communication. In a case where an incoming call signal is received from another information processing apparatus connected via a network, a control unit determines whether a connection is established with an external device based on the predetermined profile used at the time of the wireless communication. When determined that the connection is not established with the external device based on the predetermined profile used for a wireless communication performed by a communication unit, a connection request based on a predetermined profile is generated. While following a response from the external device to the connection request, via the communication unit, a communication is established with the external device based on the predetermined profile used at the time of the wireless communication.

### BACKGROUND OF THE INVENTION

1. Field of the Invention

The present invention relates to an information processing apparatus. In particular, the invention relates to an information processing apparatus capable of carrying out a call control with an external device at the time of outgoing and incoming calls.

2. Description of the Related Art

In recent years, as a wireless communication technology which can be applied to electronic devices, for example, the Bluetooth standard (registered trademark) has been known. When this wireless communication technology based on the Bluetooth standard is utilized, audio data can be transferred from a mobile information terminal such as a cellular phone and a portable music player to an external device such as a head set, for example, without using an audio cable.

In the Bluetooth standard, “Advanced Audio Distribution Profile (A2DP)” and “Generic Audio/video Distribution Profile” are known as profiles for audio data transmission. These profiles are specifications for carrying out streaming transfer of audio data between devices which are connected via the Bluetooth standard in real time.

Also, in a case where audio data is transferred from the cellular phone to an external device such as a head set or an on-vehicle device by using the Bluetooth standard, such a technology is known related to an AV remote control service for controlling transfer, play and stop of the audio data by transmitting a command to the cellular phone with use of a remote controller which is previously provided to the external device. A specification of this technology related to the AV remote control service is regulated by the standard of “AVRCP (Audio/video Remote Control Profile)”.

Furthermore, “Hands-Free Profile (HFP)” and “Bluetooth Hands-Free Profile Application Guideline” are known as profiles for a call control at the time of outgoing and incoming calls. This is a standard with which it is possible to carry out a conversation call in the external device in a hands-free state by performing a call control processing (a series of processing from connection request, calling, response, and conversation, to termination) at the time of outgoing and incoming phone calls with the external device (for example, the head set, the on-vehicle device, etc.) which is capable of wirelessly communicating with the cellular phone.

It should be noted that such a technology is known with which an incoming call alert can be output without interrupting the sound which is being output in a case where an incoming phone call occurs in the cellular phone while a stereo sound based on a stereo sound source is output (for example, refer to Japanese Unexamined Patent Application Publication No. 2005-143051).

However, in order to perform the call control processing at the time of performing outgoing and incoming phone calls by using the hands-free function with the external device (for example, the head set, the on-vehicle device, etc.), which is capable of wirelessly communicating with the cellular phone, first, a connection based on the HFP needs to be established between both the devices, and after the establishment of the connection based on the HFP, it is necessary to carry out an incoming call response operation on the external device side. For that reason, when the audio data is transferred between the cellular phone and the external device in real time with use of a streaming method, even in a case where an incoming call is generated from another cellular phone, a connection based on the HFP needs to be first established between both the devices, and after the establishment of the connection based on the HFP, it is necessary to carry out the incoming call response operation on the external device side. Therefore, there is a problem that ease of use is not satisfactory to a user.

### SUMMARY OF THE INVENTION

The present invention to provide has been made in view of the above-mentioned situation, and it is an object of the invention to provide an information processing apparatus in which it is possible to improve an operability at the time of carrying out a call control with an external device at the time of an incoming call.

In order to solve the above-mentioned problem, according to an aspect of the present invention, there is provided an information processing apparatus, including: a communication unit configured to communicate between the information processing apparatus and an external device via a short distance wireless communication; a determination unit configured to determine whether, in a case where an incoming call signal is received from another information processing apparatus connected to the information processing apparatus via a wireless network, a connection based on a predetermined profile used for the wireless communication by the communication unit is established with the external device; and a connection unit configured to generate a connection request based on the predetermined profile in a case where the determination unit determines that the connection based on the predetermined profile used for the wireless communication by the communication unit is not established with the external device, and establish a connection based on the predetermined profile used for the wireless communication, with the external device via the communication unit in accordance with a response with respect to the generated connection request from the external device.

In order to solve the above-mentioned problem, according to another aspect of the present invention, there is provided an information processing apparatus, including: a communication unit configured to communicate between the information processing apparatus and an external device via a short distance wireless communication; a connection control unit configured to generate a connection request based on the predetermined profile, if the connection based on the predetermined profile used for the wireless communication by the communication unit is not established with the external device, and configured to establish a connection based on the predetermined profile used for the wireless communication, with the external device via the communication unit in accordance with a response with respect to the generated connection request from the external device.

According to the aspect of the present invention, it is possible to improve the operability at the time of carrying out the call control with the external device at the time of the incoming call.

### BRIEF DESCRIPTION OF THE DRAWINGS

FIG. 1 illustrates a schematic configuration of an information transmitting and receiving system according to an embodiment of the present invention;

FIGS. 2A and 2B illustrate external appearance configurations of a cellular phone which can be applied to an information processing apparatus according to the embodiment of the present invention;

FIGS. 3A and 3B illustrate other external appearance configurations of the cellular phone which can be applied to the information processing apparatus according to the embodiment of the present invention;

FIG. 4 is a block diagram of an internal configuration of the cellular phone which can be applied to the information processing apparatus according to the embodiment of the present invention;

FIG. 5 is a flowchart for describing a call control processing in the cellular phone of FIG. 4;

FIG. 6 is a flowchart representing a specific processing sequence between the cellular phone and a head set at the time of executing the call control processing which is described by using the flowchart of FIG. 5;

FIG. 7 is a flowchart for describing an automatic connection destination setting processing in the cellular phone of FIG. 4;

FIG. 8 is a flowchart for describing an automatic connection destination display processing in the cellular phone of FIG. 4;

FIG. 9 is a flowchart for describing another call control processing in the cellular phone of FIG. 4; and

FIG. 10 is a flowchart representing a specific processing sequence between the cellular phone and a head set at the time of executing the call control processing which is described by using the flowchart of FIG. 9.

### DESCRIPTION OF THE PREFERRED EMBODIMENTS

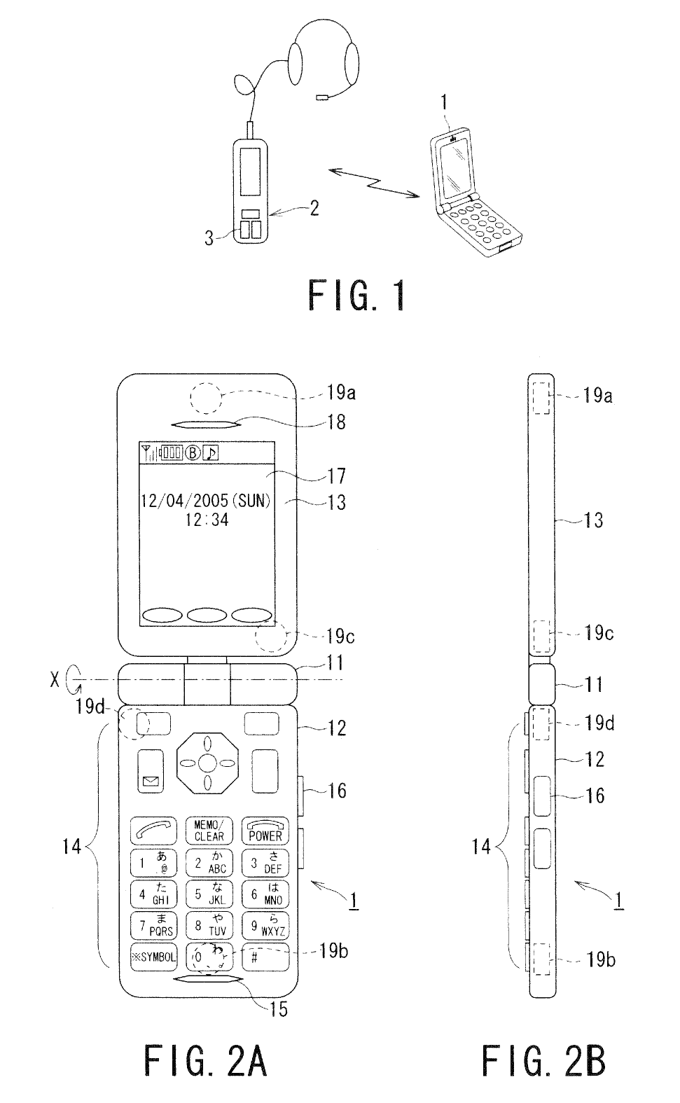

Hereinafter, embodiments of the present invention will be described with reference to the drawings. As illustrated in FIG. 1, a head set 2, which can be applied as an external device according to an embodiment of the present invention, is arranged in a vicinity of a cellular phone 1. The head set 2 can receive audio data transferred from the cellular phone 1 by using a wireless communication (for example, the Bluetooth standard) and can reproduce the received audio data in real time. In addition, it is possible to carry out a call control at the time of incoming and outgoing calls with Hands-Free Profile between the cellular phone and the head set 2. The head set 2 is provided with a remote controller 3 which is capable of remotely operating the cellular phone 1 via a wireless communication. It should be noted that an in-vehicle device may be used as the external device other than the head set 2.

FIGS. 2A and 2B illustrate external appearance configurations of the cellular phone 1 which can be applied to an information processing apparatus according to an embodiment of the present invention. FIG. 2A illustrates an external appearance configuration of the cellular phone 1 opened at about 160 degrees as viewed from the front, and FIG. 2B illustrates an external appearance configuration of the cellular phone 1 opened as viewed from the side.

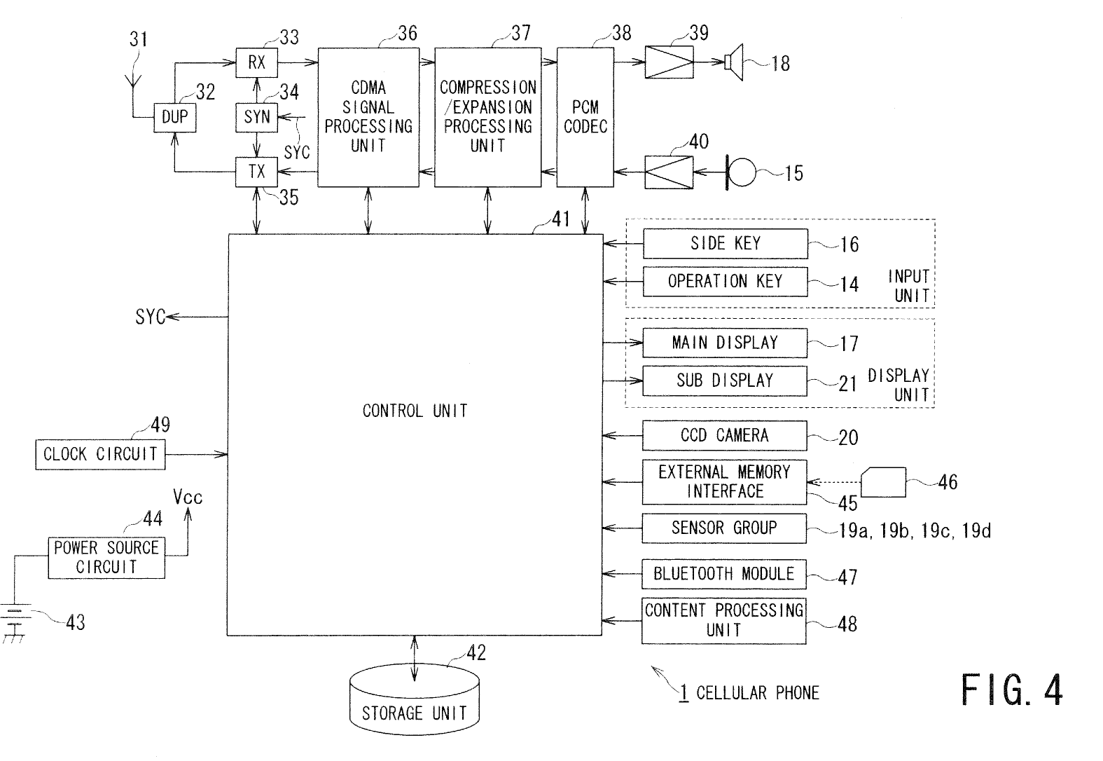

As illustrated in FIGS. 2A and 2B, the cellular phone 1 includes a first casing 12 and a second casing 13 which are hinge-connected with a hinge part 11 at the center. And, the cellular phone is formed so as to be foldable in an arrow X direction via the hinge part 11. At a predetermined location inside the cellular phone 1, an antenna for transmission and reception (an antenna 31 in FIG. 4 which will be described later) is provided. The cellular phone 1 is adapted to transmit and receive a radio wave with a base station via the built-in antenna.

The first casing 12 is provided with operation keys 14 on its surface, such as alphanumeral keys from “0” to “9”, an outgoing call key, a redial key, a power key, a clear key, and an electronic mail key. It is possible to input various instructions by using the operation keys 14.

The first casing 12 is provided with an arrow key and a confirmation key as the operation keys 14 in an upper part. As a user operates the arrow key in up, down, left, and right directions, an allocated cursor can be moved in the up, down, left, and right directions. To be more specific, various operations are executed such as a scroll operation of a telephone directory list and an electronic mail displayed on a main display 17 provided to the second casing 13, a page turning over operation of a simplified home page, and an image feed operation.

In addition, various functions can be confirmed by pressing the confirmation key. For example, in the first casing 12, in accordance with the operation of the arrow key by the user, a desired telephone number is selected from a plurality of telephone numbers in the telephone directory list displayed on the main display 17. When the confirmation key is pressed in an inside direction of the first casing 12, the selected telephone number is confirmed and an outgoing call processing is performed for the telephone number.

Furthermore, the first casing 12 is provided with the electronic mail key on the left of the arrow key and the confirmation key. When the electronic mail key is pressed in the inside direction of the first casing 12, it is possible to call mail transmission and reception functions. A browser key is provided on the right of the arrow key and the confirmation key. When the browser key is pressed in the inside direction of the first casing 12, it is possible to carry out a view of Web page data.

In addition, the first casing 12 is provided with a microphone 15 at a lower part of the operation keys 14. With the microphone 15, voice of the user at the time of conversation is collected. Also, the first casing 12 is provided with a side key 16 with which operations of the cellular phone 1 are carried out.

It should be noted that a battery pack is inserted to be attached on a back surface side of the first casing 12. When the power key is turned ON, electric power is supplied to the respective circuit units from the battery pack to activate the units in an operable state.

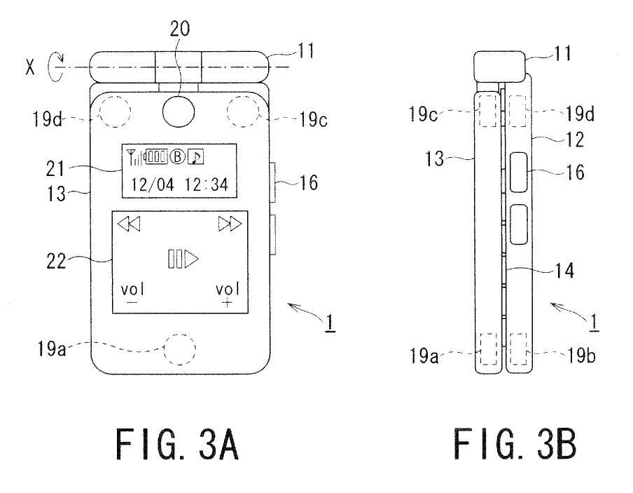

On the other hand, the second casing 13 is provided with the main display 17 on its front. In addition to the reception state of the radio wave, the battery remaining amount, other party names and telephone numbers registered as the telephone directory and the transmission history, the main display 17 can display the contents of the electronic mail, the simplified home page, an image picked up by a CCD (Charge Coupled Device) camera (a CCD camera 20 in FIGS. 3A and 3B which will be described later), a content received from an external content server, and a content stored in a memory card (a memory card 46 in FIG. 4 which will be described later). Also, a receiver (earpiece) 18 is provided at a predetermined upper position of the main display 17. With this configuration, the user can perform the voice conversation. It should be noted that a speaker (not shown) as an audio output unit other than the receiver 18 is provided at a predetermined position of the cellular phone 1.

Also, magnetic sensors 19a, 19b, 19c, and 19d for detecting the state of the cellular phone 1 are provided at predetermined positions inside the first casing 12 and the second casing 13.

FIGS. 3A and 3B illustrate other external appearance configurations of the cellular phone 1 which can be applied to the information processing apparatus according to the embodiment of the present invention. A state of the cellular phone 1 in FIGS. 3A and 3B refers to a state in which the cellular phone 1 is turned from the state in FIGS. 2A and 2B in an arrow X direction. FIG. 3A illustrates an external appearance configuration of the cellular phone 1 closed as viewed from the front, and FIG. 3B illustrates an external appearance configuration of the cellular phone 1 closed as viewed from the side.

At an upper part of the second casing 13, the CCD camera 20 is provided. With the CCD camera 20, it is possible to pick up an image of a desired photography target. A sub display 21 is provided at a lower part of the CCD camera 20. An antenna pictogram indicating the current antenna sensitivity, a battery pictogram indicating the current battery remaining amount of the cellular phone 1 and the current time are displayed on the sub display 21.

Furthermore, an electrostatic touch pad 22 is provided at a lower part of the sub display 21. The electrostatic touch pad 22 is apparently composed of one sheet of touch pad, but sensors which are not shown are provided at a plurality of positions. When the user touches a position in the vicinity of sensor, the sensor detects the touching. And a rewinding function, a fast forward function, an audio volume down operation, an audio volume up operation, a reproduction operation and a pause operation are executed in accordance with the detection by the sensor.

FIG. 4 illustrates an inner configuration of the cellular phone 1 which can be applied to the information processing apparatus according to the embodiment of the present invention. A radio signal transmitted from the base station is received by the antenna 31, and thereafter input to a receiver (RX) 33 via an antenna duplexer (DUP) 32. The receiver 33 may perform mixing of the received radio signal with a local oscillator signal output from a frequency synthesizer (SYN) 34 to down-convert the received radio signal into an intermediate frequency signal. Then, the receiver 33 generates a reception baseband signal by performing a quadrature demodulation (quadrature detection) on the down-converted intermediate frequency signal. The receiver 33 outputs the generated baseband signal to a CDMA signal processing unit 36. It should be noted that the frequency of the local oscillator signal generated from the frequency synthesizer 34 is instructed on the basis of a control signal SYC output from a control unit 41.

The CDMA signal processing unit 36 is provided with a RAKE receiver. The RAKE receiver despreads a plurality of paths included in the reception baseband signal with the respective spread codes (that is, the same spread code as the spread code of the spread reception signal). Then, after the phase in the despread signals of the respective paths is adjusted, the despread signals of the respective paths are coherently RAKE-combined by the RAKE receiver. The data series after the Rake combining is subjected to deinterleave and channel decoding (error correction decoding), and thereafter a binary data determination is carried out. With this configuration, it is possible to obtain reception packet data of a predetermined transmission format. The reception packet data is input to a compression/expansion processing unit 37.

The compression/expansion processing unit 37 is composed of a DSP (Digital Signal Processor). The compression/expansion processing unit 37 separates the reception packet data output from the CDMA signal processing unit 36 in a multiplexer/demultiplexer for each media, and perform a decoding processing on the separated data for each media. In the conversation mode, speech data corresponding to the conversation voice included in the reception packet data is decoded by way of speech codec. Also, like a television telephone mode, when motion image data is included in the reception packet data, the motion image data is decoded by way of video codec. Furthermore, when the reception packet data is a download content, after this download content is expanded, the expanded download content is output to the control unit 41.

The digital speech signal obtained through the decoding processing is supplied to a PCM codec 38. The PCM codec 33 may perform a PCM decoding on the digital speech signal output from the compression/expansion processing unit 37 and output the analog speech signal after the PCM decoding to a receiver amplifier 39. This analog speech signal is amplified by the call receiver amplifier 39 and thereafter output from the receiver 18.

The digital motion image signal decoded by way of the video codec through the compression/expansion processing unit 37 is input to the control unit 41. The control unit 41 displays the motion image based on the digital motion image signal output from the compression/expansion processing unit 37 on the main display 17 via a video RAM (for example, a VRAM or the like) which is not shown. It should be noted that the control unit 41 can display not only the received motion image data but also the motion image data picked up by the CCD camera 20 on the main display 17 via the video RAM.

In a case where the reception packet data is the electronic mail, the compression/expansion processing unit 37 supplies the electronic mail to the control unit 41. The control unit 41 instructs a storage unit 42 to store the electronic mail supplied from the compression/expansion processing unit 37. Then, in accordance with the operation by the user on the operation keys 14 as the input unit, the control unit 41 reads out this electronic mail stored in the storage unit 42 and displays the read electronic mail on the main display 17.

On the other hand, in the conversation mode, the speech signal (analog speech signal) of the speaker (user) input to the microphone 15 is amplified to an appropriate level by a transmitter amplifier 40, and then subjected to a PCM encoding by the PCM codec 38. The digital speech signal after the PCM encoding is input to the compression/expansion processing unit 37. Also, the motion image signal output from the CCD camera 20 is digitalized by the control unit 41 to be input to the compression/expansion processing unit 37. Furthermore, the electronic mail as text data generated by the control unit 41 is also input to the compress ion/expansion processing unit 37.

The compression/expansion processing unit 37 may perform a compression encoding on the digital speech signal output from the PCM codec 38 in a format in accordance with a predetermined transmission data rate. With this configuration, the speech data is generated. Also, the compression/expansion processing unit 37 performs a compression encoding on the digital motion image signal output from the control unit 41 to generate the motion image data. Then, the compression/expansion processing unit 37 multiplexes the speech data and the motion image data in the multiplexer/demultiplexer in accordance with a predetermined transmission format. The compression/expansion processing unit 37 packetizes the data multiplexed in the multiplexer/demultiplexer. The compression/expansion processing unit 37 outputs the transmission packet data after the packetization to the CDMA signal processing unit 36. In a case where the electronic mail is output from the control unit 41, the compression/expansion processing unit 37 multiplexes the electronic mail into the transmission packet data.

The CDMA signal processing unit 36 performs a spread spectrum processing on the transmission packet data output from the compression/expansion processing unit 37, with use of a spread code allocated to the transmission channel. Then, the CDMA signal processing unit 36 outputs the output signal after the spread spectrum processing to a transmitter (TX) 35. The transmitter 35 modulates the signal after the spread spectrum processing by using a digital modulation method such as a QPSK (Quadrature Phase Shift Keying) method. The transmitter 35 synthesizes the transmission signal after the digital modulation with the local oscillator signal generated from the frequency synthesizer 34 to up-convert the transmission signal into the radio signal. Then, the transmitter 35 performs a high frequency amplification on the radio signal generated through the up-conversion so as to obtain the transmission power level which is instructed by the control unit 41. The radio signal subjected to the high frequency amplification is supplied to the antenna 31 via the antenna duplexer 32 and transmitted from the antenna 31 to the base station.

In addition, the cellular phone 1 is provided with an external memory interface 45. The external memory interface 45 is provided with a slot to which the memory card 46 can be attached and detached. The memory card 46 is one type of flash memory cards represented by a NAND type flash memory card and a NOR type flash memory card. In the memory card 46, write and read of various data such as images, speech, and music can be performed via a ten-pin terminal. Furthermore, the cellular phone 1 is provided with a Bluetooth module 47 which performs a wireless communication based on the Bluetooth standard (registered trademark). The cellular phone performs a wireless communication with the head set 2 or the like located in the vicinity of the cellular phone 1, with use of the Bluetooth module 47. Of course, a wireless communication other than the Bluetooth standard (for example, an infrared communication) may be used.

A content processing unit 48 has a decoder and an encoder. If coded audio data is received from the control unit 41, the content processing unit 48 once decodes the coded audio data according to a coding method such as AAC, aacPlus, MP3, ATRAC, or SBC. Also, if needed, the content processing unit 48 re-encodes the analog audio data which is obtained by decoding the coded audio data. In addition, if the cellular phone may have a terrestrial digital one-segment broadcast wave receiver, received broadcasting signal is divided into audio packets and video packets at the terrestrial digital on-segment broadcast wave receiver. And thereafter the content processing unit 21 decodes coded audio data extracted from the audio packets and video data extracted from the video packets. The MPEG4 and H.264 standard is generally used for the video data, thereof, the content processing unit 48 decodes the coded video data according to the MPEG4 and H.264 standard. Furthermore, the cellular phone 1 is provided with a clock circuit (timer) 49 for measuring the current time.

The control unit 41 is composed of a CPU (Central Processing unit), a ROM (Read Only Memory) and a RAM (Random Access Memory). The CPU executes various processings while following programs stored in the ROM or various application programs loaded from the storage unit 42 to the RAM, and also generates various control signals to be supplied to the respective units, thus controlling the cellular phone 1 in an overall manner. The RAM appropriately stores data necessary for the CPU to execute the various processings.

In addition, if the date, is transmitted and received with the head set 2 as the external device, the control unit 41 controls the communication based on the Bluetooth module 47 in accordance with various profiles such as A2DP, HFP, and AVRCP (Audio/video Remote Control Profile) in an overall manner, with use of communication protocols such as OBEX (Object Exchange), RFCOMM (RS232 Serial Cable Emulation Profile), and SDP (Service Discovery Protocol). It should be noted that these communication protocols and profiles, and the like compose a stack having an upper application program to a lower physical layer which are sequentially stacked.

The storage unit 42 is composed, for example, of a flash memory which is a non-volatile memory in which electrical rewrite and deletion can be performed, an HDD (Hard Disc Drive), or the like. The storage unit 42 stores the various application programs to be executed by the CPU of the control unit 41 or various data groups. A power source circuit 44 generates a predetermined operation power source voltage Vcc on the basis of the output of a battery 43 to be supplied to the respective circuit units.

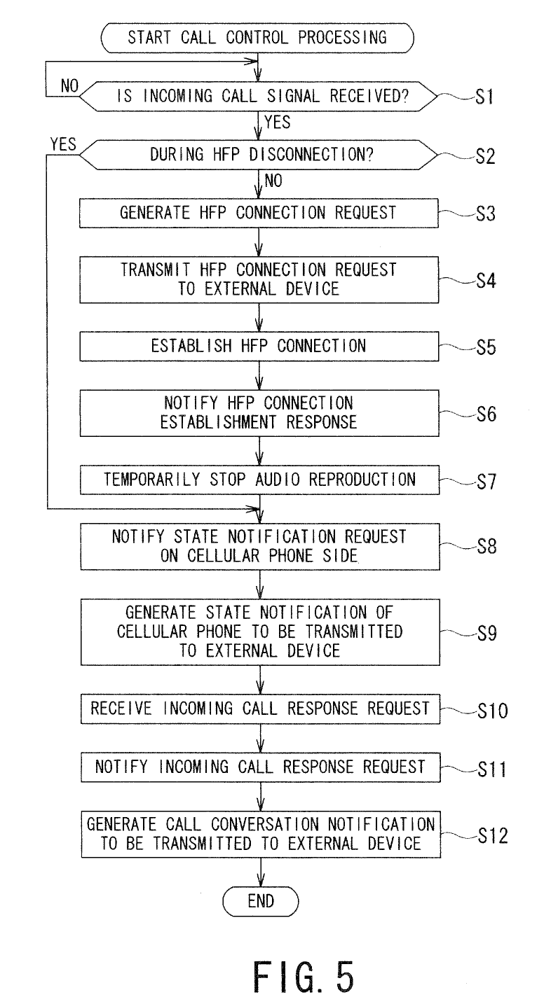

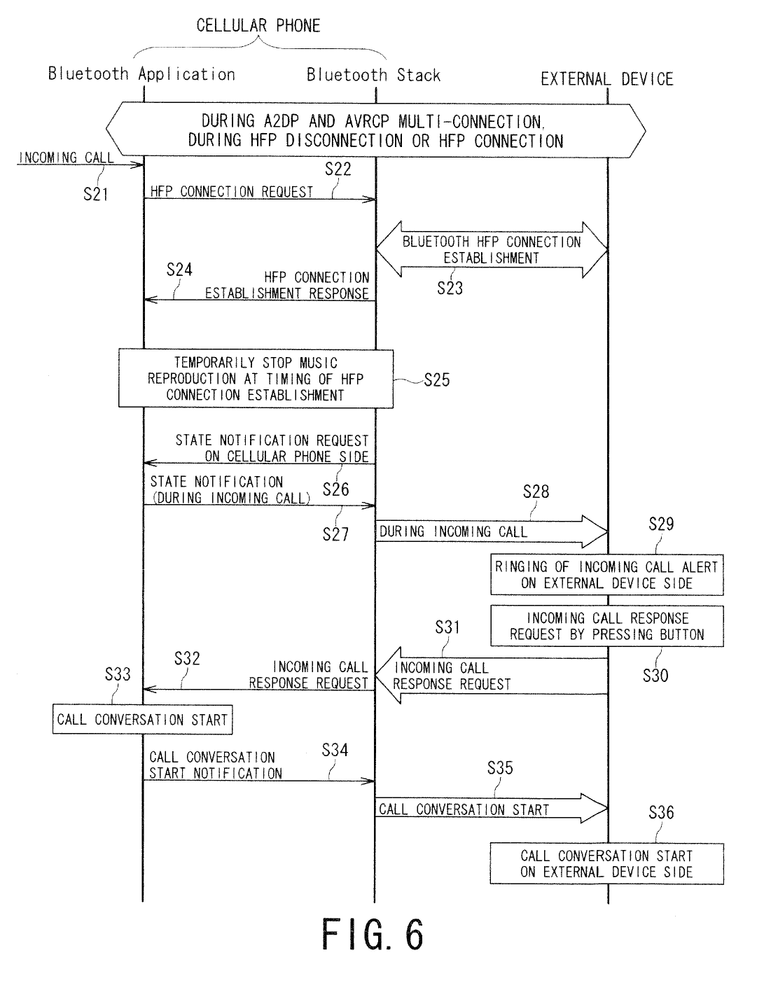

Next, with reference to a flowchart of FIG. 5, a call control processing at the time of an incoming call in the cellular phone 1 of FIG. 4 will be described. This control processing is started when multi-connection is established between the cellular phone 1 and the head set 2 via the Bluetooth module 47 based, for example, on a plurality of profiles such as the A2DP and the AVRCP, and during the HFP disconnection while the audio data is transferred from the cellular phone 1 with use of a streaming method or during the multi-connection also including the HFP connection, the incoming call signal is received from another cellular phone 1 via the antenna 31. It should be rioted that FIG. 6 represents a specific sequence for the processing between the cellular phone 1 and the head set 2 when the call control processing which is described by using the flowchart of FIG. 5 is executed.

In step S1, the control unit 41 determines whether an incoming call signal from the other cellular phone 1 or a land-line phone apparatus is received via the antenna 31. The processing stands by until it is determined that the incoming call signal from the other cellular phone 1, the land-line phone apparatus, or the like is received via the antenna 31 (step S21 of FIG. 6).

In step S1, in a case where it is determined that the control unit 41 determines that the incoming call signal from the other cellular phone 1 is received via the antenna 31, in step S2, the control unit 41 determines whether at the time of the incoming call, the multi-connection is established based on a plurality of profiles such as the A2DP and the AVRCP and while the audio data is transferred from the cellular phone 1 with use of the streaming method, the HFP connection is still not established (step S21 of FIG. 6).

In step S2, in a case where the control unit 41 determines that after the incoming call signal is received, the multi-connection is established based on a plurality of profiles such as the A2DP and the AVRCP and while the audio data is transferred from the cellular phone 1 with use of the streaming method, the HFP connection is still not established, the control unit 41 executes a Bluetooth Application in step S3 to generate an HFP connection request for requesting the HFP connection with the head set 2 as the external device and notify the Bluetooth module 47 of the thus generated HFP connection request via a Bluetooth Stack (step S22 of FIG. 6). It should be noted that at this time, the control unit 41 of the cellular phone 1 may control a speaker to output an incoming call alert based on the reception of the incoming call signal in step S1. Also, the control unit 41 of the cellular phone 1 may control a speaker to output an incoming call alert based on the reception of the incoming call signal in step S1 the ringing unit outputs an incoming call alert until the connection based on the predetermined profile used for the wireless communication is established.

In step S4, the Bluetooth module 47 transmits the HFP connection request via the Bluetooth standard to the head set 2 as the external device, in accordance with the notification of the HFP connection request from the control unit 41. After that, the head set 2 as the external device receives the HFP connection request, and the head set 2 transmits an HFP connection establishment response which is a response to the HFP connection request to the cellular phone 1. Then, in step S5, the Bluetooth module 47 of the cellular phone 1 receives the HFP connection establishment response transmitted from the head set 2 as the external device. Then, the control unit 41 establishes the connection based on the HFP between the cellular phone 1 and the head set 2 via the Bluetooth Stack (step S23 of FIG. 6). It should be noted that in a case where the HFP connection is failed, and thereafter, when the HFP connection is not established for a predetermined period of time which is previously set (for example, 0 to 3 seconds, etc.), the control unit 41 may execute an application related to a conversation call, and carry out a conversation call processing via the antenna 31 after the ringing of the incoming call alert on the cellular phone 1 side and the response by the user.

In step S6, the control unit 41 notifies the Bluetooth Application of the HFP connection establishment response received by the Bluetooth module 47 via the Bluetooth Stack (step S24 of FIG. 6). In step S7, the control unit 41 executes the Bluetooth Application, and on the basis of the notified HFP connection establishment response, recognizes the establishment of the connection based on the HFP between the cellular phone 1 and the head set 2. Also, the control unit 41 temporarily stops the music reproduction at a timing at which the HFP connection is established. That is, the streaming transfer of the audio data based on the A2DP along with the execution of the media player function is temporarily stopped (step S25 of FIG. 6).

In step S8, when the music reproduction is temporarily stopped, the control unit 41 notifies the Bluetooth Application of the request for the current state notification on the cellular phone 1 side (state notification request) from the Bluetooth module 47 via the Bluetooth Stack (step S26 of FIG. 6). In step S9, in accordance with the request for the current state notification on the cellular phone 1 side from the Bluetooth module 47, the control unit 41 executes the Bluetooth Application to generate the current state notification request of the cellular phone 1 (that is, the state notification during the incoming call) and notify the Bluetooth module 47 of the thus generated current state notification request of the cellular phone 1 via the Bluetooth Stack (step S27 of FIG. 6).

The Bluetooth module 47 transmits the current state notification request of the cellular phone 1 from the control unit 41 to the head set 2 as the external device via the Bluetooth standard (step S28 of FIG. 6). After that, the head set 2 as the external device receives the current state notification request of the cellular phone 1 (that is, the state notification during the incoming call) transmitted from the cellular phone 1. The head set 2 recognizes that the current state of the cellular phone 1 is in the state during the incoming call, and also starts the ringing of the incoming call alert along with the incoming call (for example, a fixed sound “beep, beep”) (step S29 of FIG. 6). When the user instructs an incoming call response by pressing the remote controller 3 of the head set 2, the head set 2 generates an incoming call response request for requesting the incoming call response (step S30 of FIG. 6). The head set 2 transmits the thus generated incoming call response request via the Bluetooth standard to the cellular phone 1 (step S31 of FIG. 6).

In step S10, the Bluetooth module 47 of the cellular phone 1 receives the incoming call response request transmitted from the head set 2 as the external device. In step S11, the control unit 41 notifies the Bluetooth Application of the incoming call, response request received by the Bluetooth module 47 via the Bluetooth Stack (step S32 of FIG. 6). After that, the conversation call processing is started between the cellular phone 1 (the head set 2) and the other cellular phone or the land-line phone apparatus (step S33 of FIG. 6).

In step S12, when the conversation call processing is started, the control unit 41 executes the Bluetooth Application to generate a conversation call start notification for notifying the start of the conversation call in the cellular phone 1 and notify the Bluetooth module 47 of the thus generated conversation call start notification via the Bluetooth Stack (step S34 of FIG. 6). The Bluetooth module 47 transmits the conversation call start notification from the control unit 41 to the head set 2 as the external device via the Bluetooth standard (step S35 of FIG. 6). After that, the head set 2 as the external device receives the conversation call start notification transmitted from the cellular phone 1, and the conversation call processing is started between the other cellular phone or the land-line phone apparatus and the head set 2 via the cellular phone 1 (step S36 of FIG. 6).

On the other hand, in step S2, in a case where the control unit 41 determines that after the incoming call signal is received, the multi-connection is established based, for example, on a plurality of profiles such as the A2DP and the AVRCP and while the audio data is transferred from the cellular phone 1 with use of the streaming method, the HFP connection is being established, it is not necessary to establish the HFP connection. Thus, the processing in steps S3 to S7 is skipped and the HFP connection processing is not performed. The processing is advanced to step S8. Then, the head set 2 as the external device receives the conversation call start notification transmitted from she cellular phone 1, and the conversation call processing is started between the other cellular phone or the land-line phone apparatus and the head set 2 via the cellular phone 1(steps S26 to S36 of FIG. 6).

According to the embodiment of the present invention, the communication is established via the short distance communication between the cellular phone 1 and the opposing head set 2 as the external device. In a case where the incoming call is generated from the other cellular phone or the land-line phone apparatus connected to the cellular phone 1 via the network, it is determined whether the connection based on the predetermined profile (for example, the HFP, etc.) used at the time of the wireless communication by the Bluetooth module 47 is established with the head set 2. In a case where it is determined that the connection based on the predetermined profile used at the time of the wireless communication is established with the head set 2, it is possible to establish the connection based on the predetermined profile used at the time of the wireless communication via the Bluetooth module 47.

With this configuration the multi-connection based on a plurality of profiles such as the A2DP and the AVRCP is established between the cellular phone 1 and the head set 2 via the Bluetooth module 47. While the audio data is transferred from the cellular phone 1 with use of the streaming method, during the HFP disconnection, when the incoming call is received from the other cellular phone 1 via the antenna 31, by using this incoming call as a trigger, the connection processing based on the HFP is automatically started between the head set 2 as the external device and the cellular phone 1. In the head set 2, at the timing at which the incoming call alert is output, the HFP connection can be already in the established state. At the time of the incoming call, without performing the HFP connection operation in the cellular phone 1 or the head set 2 by the user, and furthermore, without paying attention to the HFP connection operation on the user side, it is possible to start the conversation call processing based on the HFP connection in the head set 2. Therefore, it is possible to improve the ease of use for the user in the HFP connection, and also the smooth incoming call response can be performed on the head set as the external device. Therefore, it is possible to improve the operability and the usability at the time of carrying out the call control with the head set 2 as the external device upon the incoming call.

It should be noted that according to the embodiment of the present invention, the incoming call alert output on the head set 2 is set as a fixed sound, but the present invention is not limited to the above-mentioned case. In accordance with a preference of the user, an arbitrary incoming call alert previously set by the user may be transmitted from the cellular phone 1 to the head set 2, and the arbitrary incoming call alert may be output.

Incidentally, since various legal regulations have been enforced and under other circumstances, the external device such as the head set 2 is mainly used in a case where the user cannot use the cellular phone 1 with its hand (during the car drive, or the like). For example, when the user drives the car, in a case where a communication is performed with the cellular phone 1 by using the external device via the Bluetooth standard, the connection is previously established between the cellular phone 1 and the external device. However, depending on the external devices, if the processing is not performed with the cellular phone 1 within a certain period of time, the once established connection between the devices may be disconnected in some cases. In such a case, in order to perform the communication between the cellular phone 1 and the external device via the Bluetooth standard, it is necessary to establish the connection again. Thus connection processing to be performed again needs to be started on the basis of the connection request from the external device side or the connection request from the cellular phone 1 side.

However, in the call control processing described by using the flowchart of FIG. 5, in a case where the incoming call is generated from the other cellular phone 1 or the land-line telephone apparatus via the antenna 31, when the HFP connection request is issued from the cellular phone 1, as the user operates the remote controller 3 by chance, the HFP connection request is transmitted from the head set 2 as the external device. When this HFP connection request is received by the cellular phone 1, the HFP connection processing is redundant. Thus, it becomes difficult to complete the HFP connection processing in a single attempt manner.

In view of the above, in a case where the incoming call is generated from the other cellular phone 1 or the land-line telephone apparatus via the antenna 31, when the HFP connection request from the head set 2 as the external device is received by the cellular phone 1 and the connection processing is started, the HFP connection request from the head set 2 as the external device is regarded as the connection response to the HFP connection request which is generated by the execution of the Bluetooth Application at the time of the incoming call. Then, the HFP connection is established between the cellular phone 1 and the head set 2 as the external device. With this configuration, it is possible to improve the ease of use for the user in the HFP connection, and the smooth incoming call response can be performed on the head set as the external device. Thus, it is possible to further improve the operability and the usability at the time of carrying out the call control with the head set 2 as the external device upon the incoming call. Hereinafter, the call control processing using this method will be described.

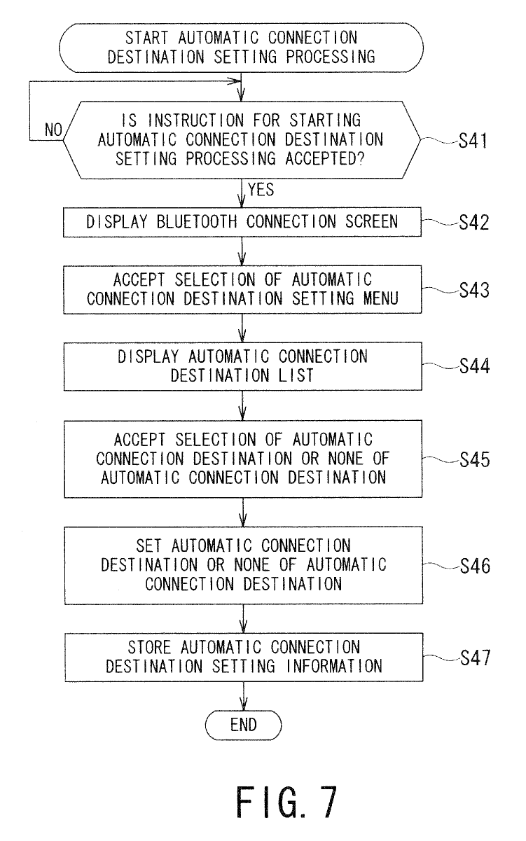

It should be noted that as a precondition for such a call control processing, the cellular phone 1 appropriately stores various pieces of information which are once subjected to pairing on the external device (an external device name, a device address, a support service (profile), and the like). Next, when the user drives a car, in a case of performing a communication by using the head set 2 as the external device with the cellular phone 1 via the Bluetooth standard, first, an automatic connection destination setting processing illustrated in a flowchart of FIG. 7 is executed in the cellular phone 1. To be more specific, first, in step S41, the control unit 41 of the cellular phone 1 determines whether the instruction for starting the automatic connection destination setting processing is accepted, as the user operates the operation key 14. The processing stands by until it is determined that the instruction for starting the automatic connection destination setting processing is accepted.

In step S41, in a case where the control unit 41 determines that the instruction for starting the automatic connection destination setting processing is accepted, in step S42, the control unit 41 controls the main display 17 to display a Bluetooth connection screen related to the connection using the Bluetooth standard on the main display 17. In step S43, the control unit 41 accepts a selection of an automatic connection destination setting menu for setting the automatic connection destination displayed on the Bluetooth connection screen as the user operates the operation key 14. In step S44, when the selection of the automatic connection destination setting menu displayed on the Bluetooth connection screen is accepted, the control unit 41 controls the main display 17 to display an automatic connection destination list related to the automatic connection destinations including a list of the external devices which support the HFP on the main display 17. In step S45, the control unit 41 accepts a selection of the automatic connection destination from among the external devices which support the HFP included in the displayed automatic connection destination list as the user operates the operation key 14. It should be noted that some users may not perform setting as the automatic connection destination, but in such a case, on the display screen of the automatic connection destination list “no setting” is selected.

In step S46, on the basis of the automatic connection destination whose selection has been accepted or the selection of “no setting”, the control unit 41 sets as the automatic connection destination for the connection via the Bluetooth standard or none of the automatic connection destination. In step S47, the control unit 41 stores the set automatic connection destination setting information in the storage unit 42.

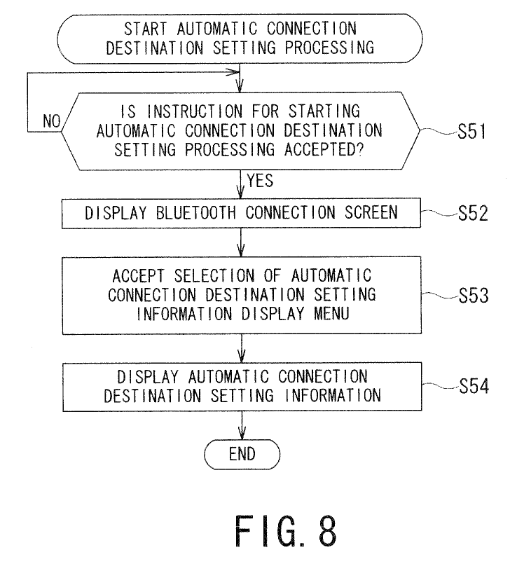

Further, as illustrated in a flowchart of FIG. 8, after that, the automatic connection destination display processing is executed in the cellular phone. That is, in step S51, in a case where the control unit 41 determines that the instruction for starting the automatic connection destination setting processing is accepted, in step S52, the control unit 41 controls the main display 17 to display a Bluetooth connection screen which is a screen related to the connection using the Bluetooth standard on the main display 17. In step S53, the Bluetooth connection screen is displayed on the Bluetooth connection screen, and a selection of the automatic connection destination setting information display menu for displaying the automatic connection destination setting information (the setting information related to the automatic connection destination) is accepted as the user operates the operation key 14. In step S54, when the selection of the automatic connection destination setting information display menu displayed on the Bluetooth connection screen is accepted, the control unit 41 displays the automatic connection destination setting information. This automatic connection destination setting information includes information related to the external device name that is the automatic connection destination, the device address, and the service to be supported.

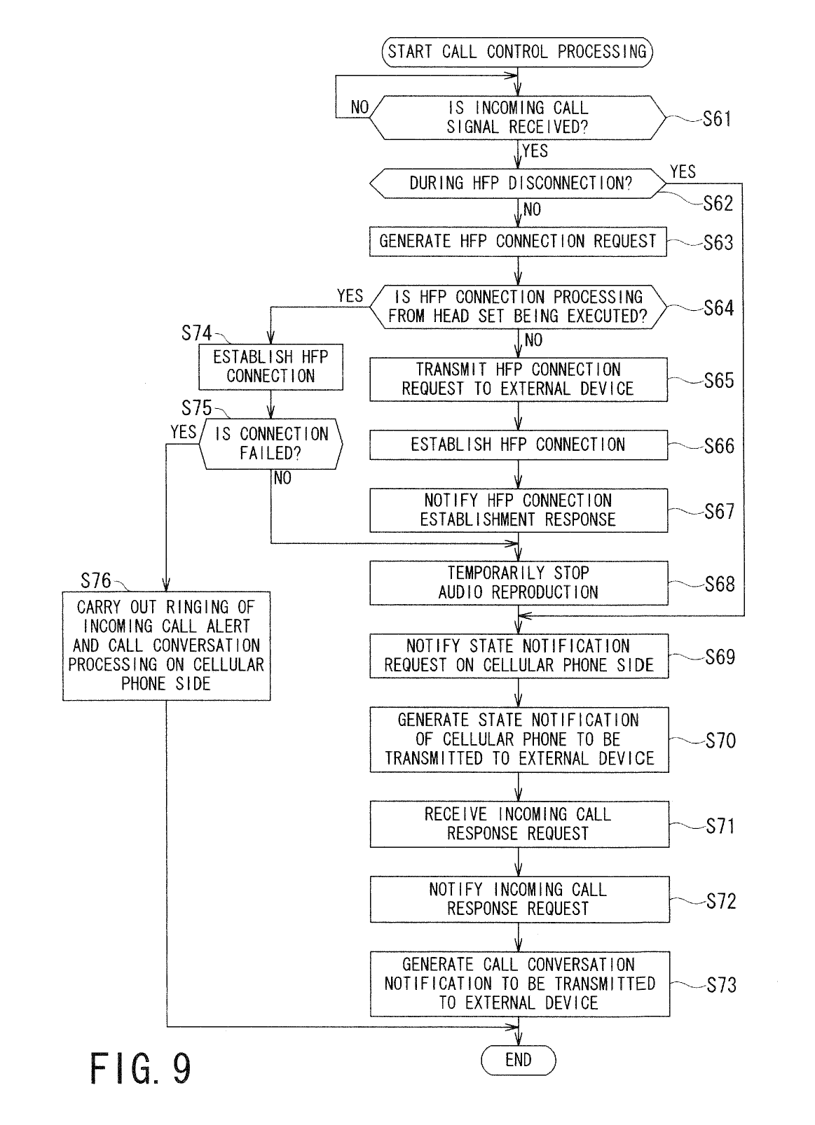

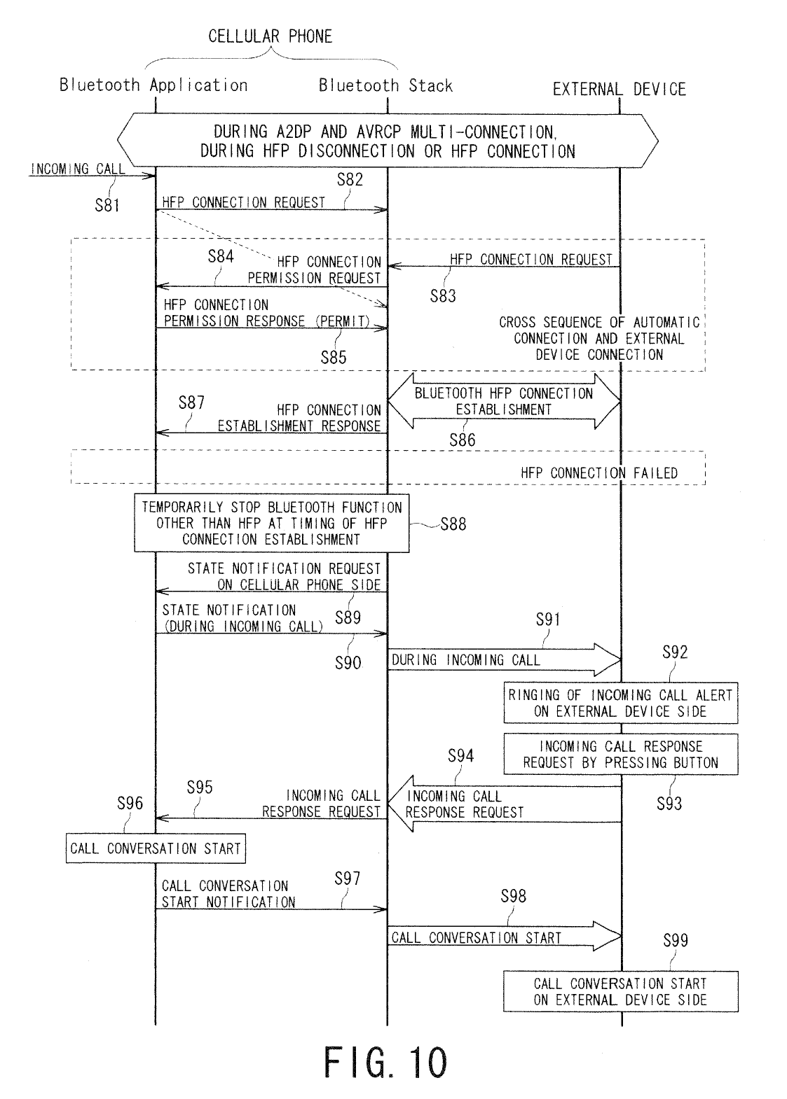

Next, with reference to a flowchart of FIG. 9, another call control processing in the cellular phone 1 of FIG. 4 will be described. This control processing is started when, for example, the multi-connection based on a plurality of profiles such as the A2DP and the AVRCP are established between the cellular phone 1 and the head set 2 via the Bluetooth module 47, and while the audio data is transferred from the cellular phone 1 with use of the streaming method, during the HFP disconnection, or during the multi-connection also including the HFP connection, the incoming call is received from the other cellular phone 1 via the antenna 31. It should be noted that FIG. 9 represents a specific processing sequence between the cellular phone 1 and the head set 2 at the time of executing the call control processing which is described by using the flowchart of FIG. 10. In addition, the processing in steps S61 to S63 and steps S65 to S73 of FIG. 9 is basically similar to that in steps S1 to S12 of FIG. 5, and a description thereof will be appropriately omitted to avoid the repetition.

In step S63, when the control unit 41 executes the Bluetooth Application to generate the HFP connection request at the time of the incoming call (steps S81 and S82 of FIG. 10), in step S64, the control unit 41 executes the Bluetooth stack to determine whether the HFP connection processing from the head set 2 is currently executed. That is, as illustrated in steps S83 to S85 of FIG. 10, in a case where the incoming call is generated from the other cellular phone 1, the land-line telephone apparatus, or the like via the antenna 31, when the HFP connection request is issued from the cellular phone 1, as the user operates the remote controller 3 by chance, the HFP connection request is transmitted from the head set 2 as the external device. If this HFP connection request is received by the cellular phone 1, the HFP connection processing is unintentionally started.

At this time, the HFP connection request transmitted from the head set 2 is received by the Bluetooth module 47 of the cellular phone 1, but some time lag exists until the Bluetooth Application is notified of an HFP connection permission request based on the HFP connection request via the Bluetooth Stack. For that reason, during this time lag, if the HFP connection request from the cellular phone 1 is issued to the Bluetooth module 47, the HFP connection processing is redundant. It becomes necessary to cancel either of the connection processings, but also the connection time taken for establishing the HFP connection between the cellular phone 1 and the head set 2 becomes longer. In view of the above, in a case where the incoming call is generated from the other cellular phone 1 or the land-line telephone apparatus via the antenna 31, when the HFP connection request from the cellular phone 1 is issued, it is determined whether the HFP connection processing from the head set 2 as the external device is already started. It should be noted that during the execution of the HFP connection processing, the incoming call ringing is not carried out in the cellular phone 1.

In step S64, in a case where it is determined that the HFP connection processing from the head set 2 is currently executed, in step S74, the Bluetooth module 47 of the cellular phone 1 prioritizes the HFP connection request from the head set 2 as the external device and regards the HFP connection request from the head set 2 as the connection establishment response to the HFP connection request generated through the execution of the Bluetooth Application at the time of the incoming call. The Bluetooth module 47 recognizes that the HFP connection establishment response transmitted from the head set 2 as the external device is received, and also, the control unit 41 establishes the connection based on the HFP between the cellular phone 1 and the head set 2 via the Bluetooth Stack (step S86 of FIG. 10).

In step S75, the control unit 41 executes the Bluetooth Application to determine whether the HFP connection is failed on the basis of the HFP connection establishment response obtained via the Bluetooth Stack. For example, in a case where link loss is generated between the cellular phone 1 and the head set 2, the HFP connection establishment becomes difficult, and it is determined that the HFP connection is failed. In step S75, in a case where it is determined that the HFP connection is not failed (that is, when determined that the HFP connection is succeeded), the processing is advanced to step S67, and the processing in step S68 and subsequent steps is executed. With this configuration, the state notification indicating that the incoming call is being performed is transmitted to the head set 2, the conversation call is started as the user operates the remote controller 3 in the head set 2 (steps S88 to S99 of FIG. 10). It should be noted that in step S68, at the timing of the HFP connection establishment, a Bluetooth function other than the HFP (for example, the music reproduction function, or the like) is temporarily stopped. At this time, the connections of the Bluetooth module 47 and the logic layer which are lower hierarchical layers, are not disconnected.

On the other hand, in step S75, in a case where it is determined that the HFP connection is failed, if the HFP connection is not established for a predetermined period of time which is previously set (for example, 0 to 3 seconds, etc.), the control unit 41 executes an application related to the conversation call, and ringing of the incoming call alert and the conversation call processing are performed on the cellular phone 1 side via the antenna 31.

In step S64, in a case where it is determined that the HFP connection processing from the head set 2 is not currently executed (that is, in a case where the HFP connection with the head set 2 is in the disconnected state and also the HFP connection processing from the head set 2 is not being executed), the processing is advanced to step S65. The HFP connection processing is executed in the processing in step S65 and subsequent steps. It should be noted that at this time, in a case where the head set 2 as the external device side does not support the HFP, the HFP connection processing is not performed, and the incoming call ringing processing is performed in the cellular phone 1.

With this configuration, the incoming call is generated from the other cellular phone 1 or the land-line telephone apparatus via the antenna 31, when the HFP connection request from the head set 2 as the external device is received by the cellular phone 1 and the connection processing is started, the HFP connection request from the head set 2 as the external device is regarded as the connection response to the HFP connection request generated through the execution of the Bluetooth Application at the time of the incoming call, and it is possible to establish the HFP connection between the cellular phone 1 and the head set 2 as the external device. With this configuration, even when the HFP connection processing from the head set 2 is being executed, it is possible to complete the HFP connection processing in a single attempt manner. Then, it is possible to improve the ease of use for the user in the HFP connection, and also the smooth incoming call, response can be performed on the head set as the external device. Therefore, it is possible to improve the operability and the usability at the time of carrying out the call control with the head set 2 as the external device upon the incoming call.

It should be noted that according to the embodiments of the present invention, the multi-connection based on a plurality of profiles such as the A2DP and the AVRCP, for example, are established between the cellular phone 1 and the head set 2 via the Bluetooth module 47, and while the audio data is transferred from the cellular phone 1 with use of the streaming method, during the HFP disconnection or the multi-connection also including the HFP connection, the call control illustrated in FIG. 5 or 9 is executed. However, the present invention is not limited to the above-mentioned case. For example, the present invention can be applied to a case during the HFP disconnection or the multi-connection also including the HFP connection when only an audio of a terrestrial digital one-segment broadcast wave, a radio broadcast wave, or the like is transferred to the head set 2.

It should be noted that in addition to the cellular phone 1, the present invention can also be applied to other information processing apparatuses such as a PDA (Personal Digital Assistant), a personal computer, a portable game player, a portable music player, and a portable video player.

Also, the series of processings described according to the embodiment of the present invention can be executed by using software but can also be executed by using hardware.

Furthermore, according to the embodiments of the present invention, such a processing example has been described that the steps of the flowcharts are processed in a time series manner in the stated order, but the present invention also encompasses a processing in which the steps are not necessarily processed in the time series manner and the steps are processed in a parallel manner or individually processed.

What is claimed is:

1. An information processing apparatus, comprising:
a communication unit configured to communicate between the information processing apparatus and an external device via a short distance wireless communication;
a determination unit configured to determine whether, in a case where an incoming call signal is received from another information processing apparatus connected to the information processing apparatus via a wireless network, a connection based on a predetermined profile used for the wireless communication by the communication unit is established with the external device; and
a connection unit configured to generate a connection request based on the predetermined profile in a case where the determination unit determines that the connection based on the predetermined profile used for the wireless communication by the communication unit is not established with the external device, and establish a connection based on the predetermined profile, used for the wireless communication, with the external device via the communication unit in accordance with a response with respect to the generated connection request from the external device.

2. The information processing apparatus according to claim 1, wherein if the incoming call signal is received, a multi-connection is established, which is based on plural profiles used for the wireless communication by the communication unit, with the external device.

3. The information processing apparatus according to claim 2, further comprising a control unit configured to control to temporarily stop execution of one or plural profiles other than the predetermined profile if the connection based on the predetermined profile used for the wireless communication via the communication unit is established by the connection unit.

4. The information processing apparatus according to claim 3, wherein one or plural profiles include a profile related to transferring of audio data.

5. The information processing apparatus according to claim 3, wherein while a connection with the external device in a physical layer and a logic layer in the wireless communication by the communication unit is maintained, the control unit controls to temporarily stop execution of one or plural profiles other than the predetermined profile.

6. The information processing apparatus according to claim 1, wherein if the incoming call signal is received, in a case where the connection based on the predetermined profile used for the wireless communication via the communication unit, is established by the connection unit, the connection processing by the connection unit is not performed.

7. The information processing apparatus according to claim 1, wherein the predetermined profile is a Hands-Free profile of the Bluetooth standard.

8. The information processing apparatus according to claim 1, further comprising a setting unit configured to set a connection destination to be connected by the connection unit, at the time of the wireless communication from among a plurality of the external devices,
wherein the connection unit, establishes the connection based on the predetermined profile used for the wireless communication via the communication unit with the external device set by the setting unit.

9. The information processing apparatus according to claim 8, further comprising a storing unit configured to store information related to plural external devices; and
a display unit configured to display the information related to the external device set by the setting unit.

10. The information processing apparatus according to claim 1, wherein in a case where the determination unit determines that the connection based on the predetermined profile used for the wireless communication by the communication unit is not established with the external device, if a connection processing from the external device is being executed, a connection request based on the predetermined profile is generated and also the connection request from the external device is regarded as a response from the external device with respect to the generated connection request, and the connection based on the predetermined profile used for the wireless communication is established with the external device via the communication unit.

11. The information processing apparatus according to claim 10, wherein in a case where the determination unit determines that the connection based on the predetermined profile used for the wireless communication by the communication unit is not established with the external device, if a connection processing from the external device is not being executed, the connection unit establishes a connection based on the predetermined profile used for the wireless communication, with the external device via the communication unit in accordance with a response with respect to the generated connection request from the external device.

12. The information processing apparatus according to claim 1, further comprising a ringing unit configured to output an incoming call alert corresponding to the incoming call signal from the other information processing apparatus in a case where the connection based on the predetermined profile used for the wireless communication via the communication unit by the connection unit is failed.

13. The information processing apparatus according to claim 1, further comprising a ringing unit configured to output an incoming call alert corresponding to the incoming call signal from the other information processing apparatus, if the incoming call signal is received.

14. The information processing apparatus according to claim 13, wherein the ringing unit outputs an incoming call alert corresponding to the incoming call signal until the connection based on the predetermined profile used for the wireless communication via the communication unit is established by the connection unit.

15. An information processing apparatus, comprising:
a communication unit configured to communicate between the information processing apparatus and an external device via a short distance wireless communication;
a connection control unit configured to generate a connection request based on the predetermined profile, if the connection based on the predetermined profile used for the wireless communication by the communication unit is not established with the external device, and configured to establish a connection based on the predetermined profile used for the wireless communication, with the external device via the communication unit in accordance with a response with respect to the generated connection request from the external device.
